(19) United States
(12) Patent Application Publication
(10) Pub. No.: US 2022/0316697 A1
(43) Pub. Date: Oct. 6, 2022

(54) WORKING FLUID EVAPORATOR FOR AN ETM PLANT COMPRISING A SUITABLE SPRAYING SYSTEM

(71) Applicant: NAVAL GROUP, Paris (FR)

(72) Inventor: Bertrand CLAUZADE, Paris (FR)

(21) Appl. No.: 17/596,737

(22) PCT Filed: Jun. 17, 2020
(86) PCT No.: PCT/EP2020/066813

§ 371 Date: Dec. 16, 2021

(30) Foreign Application Priority Data
Jun. 17, 2019 (FR) FR1906454

(51) Int. Cl. F22B 27/16; F03G 7/05

(52) U.S. Cl. CPC F22B 27/16; F03G 7/05

(57) ABSTRACT

The present invention relates to an evaporator of a working fluid for an OTEC plant, comprising an evaporator body, a bundle of evaporators extending along the central axis, subject to a pressure drop along this axis and suitable for evaporating the working fluid according to an evaporation profile defined based on this pressure drop and a spraying system comprising a working fluid supply network and a plurality of spray nozzles arranged on the supply network and able to spray the working fluid.

All of the spray nozzles have substantially the same spray rate and the arrangements of the spray nozzles in relation to the bundle of evaporators are chosen so as to ensure a predetermined spray profile along the central axis in accordance with the evaporation profile.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### FIELD

The present invention relates to a working fluid evaporator for an OTEC plant.

### BACKGROUND

In a manner known per se, an OTEC (for Ocean Thermal Energy Conversion or ETM in French) plant uses the temperature difference between the surface water and the deep water of the oceans to produce electricity.

Typically, such an OTEC plant comprises an evaporator wherein a working fluid is evaporated by the warm surface waters to drive a turbine, and a condenser in which this working fluid is then condensed by the cold waters of the ocean floor.

The evaporator of an OTEC plant generally has an elongated shape through which an bundle of evaporators extends. This bundle of evaporators, in the form of a plurality of pipes or plates, circulates hot water along the evaporator.

A spraying system consisting of pipes and nozzles mounted on the pipes is provided along this bundle in order to spray the working fluid in liquid state onto it. The nozzles are generally arranged evenly along the corresponding pipes.

The bundle of evaporators has a non-uniform power profile along its axial extent. In particular, at the hot water inlet, this bundle clearly has a higher power than at the hot water outlet. Thus, the bundle of evaporators experiences a pressure drop along its axial extent.

In some cases, the evaporated fluid flow rate at the hot water inlet is several times, for example four times, greater than that at the hot water outlet.

It is then conceivable that the pressure drop along the bundle of evaporators significantly impairs the efficiency of the evaporator and thus of the OTEC plant.

### SUMMARY

The object of the present invention is to provide an evaporator for an OTEC plant that is particularly efficient despite the pressure drop along the bundle of evaporators.

To this end, the subject matter of the invention is an evaporator of a working fluid for an OTEC plant, comprising:
an evaporator body of elongated shape, extending along a central axis;
a bundle of evaporators carrying hot water, extending along the central axis, undergoing a pressure drop along this central axis and capable of evaporating the working fluid along the central axis according to an evaporation profile defined based on this pressure drop;
a spraying system, comprising a working fluid supply network extending above the bundle of evaporators and a plurality of spray nozzles arranged on the supply network and capable of spraying the working fluid in the liquid state onto the bundle of evaporators in order to evaporate this working fluid;

all the spray nozzles have substantially the same spray rate and in that the arrangements of the spray nozzles in relation to the bundle of evaporators are chosen so as to ensure a predetermined spray profile along the central axis, based on the evaporation profile of the bundle of evaporators.

According to other advantageous aspects of the invention, the evaporator comprises one or more of the following features, taken alone or in any technically possible combination:
an evacuation system capable of evacuating the working fluid in gaseous state formed by the bundle of evaporators and arranged along the central axis according to the evaporation profile of the bundle of evaporators;
the predetermined spray profile has a spray rate decreasing along the central axis according to the direction of transport of the hot water through the bundle of evaporators;
the supply network takes the form of a plurality of supply pipes extending along the central axis, each spray nozzle being arranged on one of these supply pipes;
each spray nozzle is arranged along the corresponding supply pipe according to the predetermined spray profile;
each spray nozzle defines a spraying direction and is capable of spraying the working fluid in liquid state along this spraying direction;
each spray nozzle is arranged in relation to the bundle of evaporators according to its spraying direction and according to the predetermined spraying profile;
each spray nozzle defines an overlap section by its spray, with at least some of the adjacent overlap sections forming an overlap area at an overlap ratio;
the or each overlap rate is selected according to the predetermined spray profile; and
the evaporator body defines a vertical plane bisecting the evaporator body, the spray nozzles being symmetrically arranged in relation to the vertical plane.

### BRIEF DESCRIPTION OF THE DRAWINGS

These features and advantages of the invention will become apparent from the following description, given only as a non-limiting example, and made with reference to the appended drawings, in which:

FIG. 1 is a schematic side view of an evaporator according to the invention; and

FIG. 2 is a schematic cross-sectional view of the evaporator in FIG. 1 according to the cross-sectional plane II-II, visible in this FIG. 1.

### DETAILED DESCRIPTION

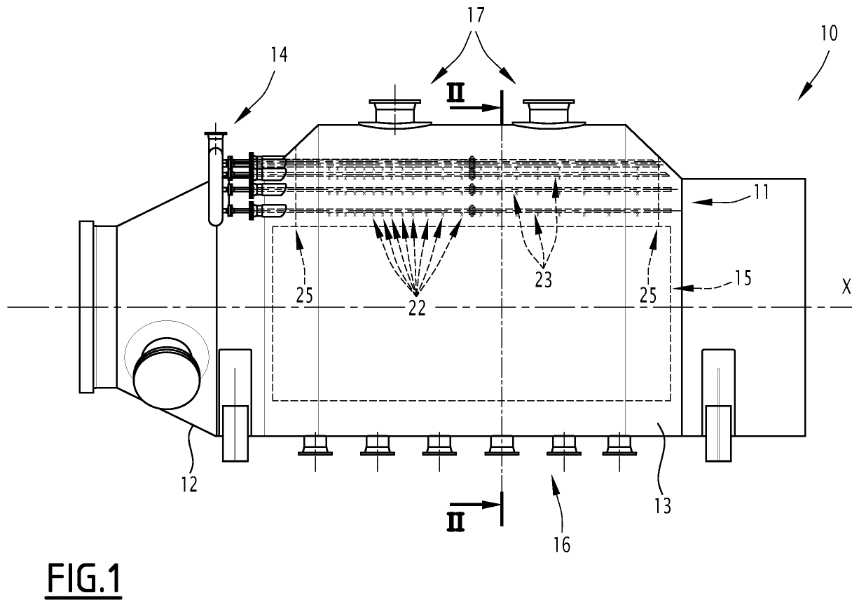

In fact, an evaporator 10 for an OTEC plant has been shown in FIG. 1. In the illustrated example, the evaporator 10 is a pipe evaporator. According to other embodiments, the evaporator is a plate evaporator.

With reference to FIG. 1, the evaporator 10 has an evaporator body 11 extended along a main axis X and having at least one substantially conical shape 12 opening into a substantially cylindrical shape 13. This body 11 is pressurized, for example.

The evaporator 10 comprises a spraying system 14, a bundle of evaporators 15, a channeling system 16 and a discharge system 17.

The bundle of evaporators 15 takes the form of a plurality of pipes passing through the cylindrical part 13 of the body 11 along the main axis X. These pipes are a few thousand in number for example, such as 3000. Thus, for reasons of legibility of FIG. 1, these pipes are not shown in this Figure.

The pipes of the bundle of evaporators 15 transport water, called hot water, i.e. surface water. This water flows through the bundle of evaporators 15 along the main axis X, for example from left to right in the example of FIG. 1.

Thus, when a working fluid sprayed via the spraying system 14 comes into contact with the pipes of the bundle 15, it vaporizes.

Further, along the central axis X, the bundle of evaporators 15 has a pressure drop due to the difference in temperatures at the hot water inlet and hot water outlet. Thus, according to this pressure drop, the bundle of evaporators 15 defines an evaporation profile corresponding then to the maximum capacity of this bundle of evaporators 15 to evaporate the working fluid along the central axis X.

The evacuation system 17 makes it possible to evacuate steam produced by the bundle of evaporators 15 and to guide it towards a turbine (non-illustrated), to make it rotate.

The channeling system 16 makes it possible for the non-vaporized working fluid to be channeled back into the evaporator 10 via the spraying system 14, for example.

The bundle of evaporators 15, the pipeline system 16 and the discharge system 17 are known per se and will not be described in detail hereafter.

The spraying system 14 extends over the bundle of evaporators 15 along substantially the entire length of the bundle of evaporators 15 within the evaporator body 11.

The spraying system 14 comprises a supply network and a plurality of spray nozzles 22 arranged on said supply network.

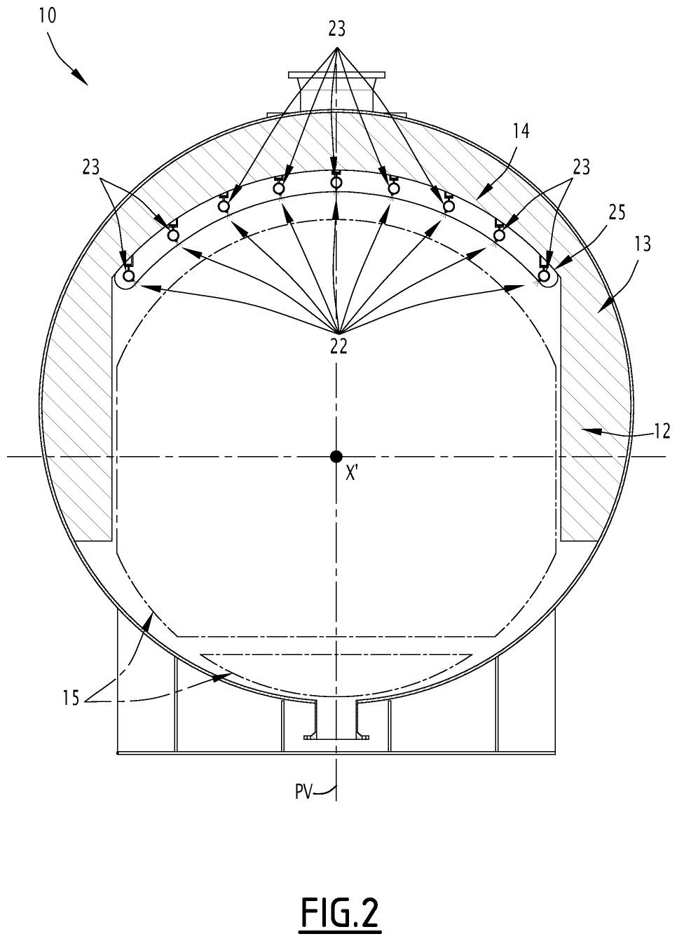

In particular, in the example of FIGS. 1 and 2, the supply network takes the form of a plurality of supply pipes 23.

Within the evaporator body 11, each supply pipe 23 extends along the main axis X above the bundle of evaporators 15. Thus, in FIG. 1, the parts of these pipes extending inside the body 11 are shown as broken lines and the parts extending outside the body 11 are shown as solid lines.

Further, as visible in FIG. 2 in cross-section, the supply pipes 23 are arranged in an upper part of the evaporator body 11 on a circular arc 25. This arc 25 is formed by suitable support means arranged at each end of the evaporator body 11, for example.

The opening of this arc of a circle is between 80° and 160° , for example.

In addition, the supply pipes 23 are evenly distributed along this arc, for example.

Thus, in the example shown in FIG. 2, nine supply pipes 21 distributed homogeneously along the arc 25 are shown.

The supply pipes 23 exit from the interior of the body 11 through the side surface of the conical part 12 of the body 11, for example. Thus, outside this body, the supply pipes 23 join a central supply pipe connected in particular to a (non-illustrated) condenser for supplying the spraying system 14 with working fluid.

The spray nozzles 22 are mounted along the supply pipes 23 inside the body 11.

Each spray nozzle 22 is capable of spraying the working fluid onto the bundle of evaporators 15 in a spraying direction.

Each spray nozzle 22 thus forms a cover section of the bundle of evaporators 15. Adjacent cover sections of at least some spray nozzles 22 form overlap areas. Each overlap area is defined according to an overlap ratio.

Further, all of the spray nozzles 22 have substantially the same spray rate.

According to the invention, the spray nozzles 22 are arranged on the supply pipes 23 so as to ensure a predetermined spray profile along the central axis X.

In particular, such a profile defines the spray rate along the entire bundle of evaporators 15 along the central axis X and is predetermined in accordance with the evaporation profile of the bundle of evaporators 15.

In other words, this profile is presented in the form of a graph, for example, on which the x-axis defines a plurality of consecutive points along the central axis X and the y-axis defines a spray rate at each of these points.

This spray profile is selected at the design of the evaporator 10, to increase the efficiency of the evaporator 10. Thus, for example, this spray profile follows the evaporation profile of the bundle of evaporators 15 in order to ensure the maximum capacity of this bundle to evaporate the working fluid.

Further, advantageously, the arrangement of the evacuation system 17 along the central axis X is adapted to the evaporation profile of the bundle of evaporators 15 and thus, to the spray profile of the spraying system.

To ensure such a spray profile while taking into account the evaporation profile, the arrangements of the spray nozzles 22 along the supply pipes 23 are adjusted.

In particular, for this purpose, according to one embodiment, two parameters relating to the arrangement of each spray nozzle 22 are set.

The first of these parameters corresponds to the position of each nozzle along the supply pipe 23 on which it is mounted.

Thus, the positions of the nozzles along the same pipe 23 are chosen according to the predetermined spray profile.

In the example of FIG. 1, the spray nozzles 22 arranged on the same pipe are spaced at an increasing distance from left to right, according to a growth law, for example, determined according to the predetermined spray profile.

Thus, in the example of this FIG. 1, the hot water is transported by the bundle of evaporators 15 from left to right and the spray profile thus has a decreasing spray rate from left to right.

Further, it is clear that the same growth law can be chosen for all the pipes 23.

The second parameter corresponds to the orientation of each nozzle in relation to the bundle of evaporators 15. This orientation is for example defined by the angle formed between the spraying direction of the corresponding nozzle and a surface of the bundle of evaporators 15.

In the example shown in FIG. 2, the spray nozzles 22 are oriented towards the center of the bundle of evaporators 15 through which the central axis X passes.

Further, in this case, the spray nozzles 22 are oriented symmetrically in relation to a vertical plane PV passing through the evaporator body 11 and including the central axis X.

Further, according to one advantageous embodiment of the invention, one or more overlap ratios, defining one or more overlap areas, are selected so as to ensure the predetermined spray profile.

Thus, according to this embodiment, adjustments of a third parameter, corresponding to the adjustments of the overlap rates between different covering sections, are also possible in order to obtain a spray profile adapted to the local evaporation rate.

It is thus conceivable that the invention has a number of advantages.

Indeed, the invention proposes achieving a predetermined spray profile by adjusting the nozzle arrangement along the bundle of evaporators.

These adjustments include adjustments of the nozzle positions, orientation and overlap rate in this bundle.

Thus, nozzles with the same spray rate can be used, which greatly simplifies the mounting and maintenance of these nozzles and reduces the likelihood of errors compared to the case where nozzles with a predetermined spray rate must be mounted in predetermined locations on the evaporator.

1. A working fluid evaporator for an OTEC plant, comprising:
an elongated evaporator body extending along a central axis;
a bundle of evaporators transporting hot water, extending along the central axis, undergoing a pressure drop along this central axis and capable of evaporating the working fluid along the central axis according to an evaporation profile defined based on this pressure drop; and
a spraying system comprising a working fluid supply network extending above the bundle of evaporators and a plurality of spray nozzles arranged on the supply network capable of spraying the working fluid in liquid state onto the bundle of evaporators in order to evaporate the working fluid;
wherein the spray nozzles have substantially the same spray flow rate and in that the arrangements of the spray nozzles in relation to the bundle of evaporators are chosen so as to ensure a predetermined spray profile along the central axis based on the evaporation profile of the bundle of evaporators.

2. The evaporator according to claim 1, further comprising an evacuation system adapted to evacuate the working fluid in a gaseous state formed by the bundle of evaporators and arranged along the central axis according to the evaporation profile of the bundle of evaporators.

3. The evaporator according to claim 1, wherein the predetermined spray profile has a decreasing spray rate along the central axis according to the direction of transport of hot water through the bundle of evaporators.

4. The evaporator according to claim 1, wherein the supply network takes the form of a plurality of supply pipes extending along the central axis, each spray nozzle being arranged on one of these supply pipes.

5. The evaporator according to claim 4, wherein each spray nozzle is arranged along the corresponding supply pipe according to the predetermined spray profile.

6. The evaporator according to claim 1, wherein each spray nozzle defines a spraying direction and is adapted to spray the working fluid in a liquid state along this spraying direction.

7. The evaporator according to claim 6, wherein each spray nozzle is arranged in relation to the bundle of evaporators according to its spraying direction and according to the predetermined spray profile.

8. The evaporator according to claim 1, wherein each spray nozzle defines an overlap section by its spray, at least some of the adjacent overlap sections forming an overlap area according to an overlap ratio.

9. The evaporator according to claim 8, wherein each overlap rate is selected according to the predetermined spray profile.

10. The evaporator according to claim 1, wherein the evaporator body defines a vertical plane bisecting said body, the spray nozzles being symmetrically arranged in relation to said vertical plane.
